(19) United States
(12) Patent Application Publication
(10) Pub. No.: US 2024/0386330 A1
(43) Pub. Date: Nov. 21, 2024

(54) DATA MATCHING AND MATCH VALIDATION USING A MACHINE LEARNING BASED MATCH CLASSIFIER

(71) Applicant: MASTERCARD INTERNATIONAL INCORPORATED, Purchase, NY (US)

(72) Inventors: Varun AJMERA, Toronto (CA); BumJune KIM, North York (CA); Sayuj Nambiar Othayoth GANAPATHIYADAN, Toronto (CA); Herve DUKUZE, North York (CA); Ravi Santosh ARVAPALLY, Hyderabad (IN)

(73) Assignee: MASTERCARD INTERNATIONAL INCORPORATED, Purchase, NY (US)

(21) Appl. No.: 18/318,187

(22) Filed: May 16, 2023

(51) Int. Cl. G06N 20/20

(52) U.S. Cl. CPC G06N 20/20

(57) ABSTRACT

The disclosure relates to methods and systems of generating matches between unmatched descriptors and known entities and training and using a machine learning-based match classifier (ML match classifier) to generate match classifications. For example, a system may access an unmatched descriptor having unstructured content and extract one or more data elements from the unmatched descriptor. The system may compare each of the extracted data elements with data records of known entities to identify candidate matches. The system may train and use the ML match classifier to validate the candidate matches. The ML match classifier may be trained based on labeled features derived from similarity metrics between two strings such as a name associated with the unmatched descriptor and a name of a candidate entity.

### BACKGROUND

Entities may share data with one another over computer networks for various purposes. In some instances, a transmitting entity may detect an anomaly based on the shared data and generate an alert message for distribution to other entities. The alert message may encode an identifier such as a descriptor that is used to identify a recipient entity that may investigate and/or mitigate the detected anomaly. The transmitting entity may transmit the alert message to an alert system, which may identify the recipient entity based on the descriptor and route the alert message to the recipient entity for investigation and/or mitigation In this way, the alert system may receive an alert message from a transmitting entity, identify a recipient entity based on the descriptor, and transmit the alert message to the recipient entity.

In some instances, the alert system may be unable to identify the recipient entity based on the descriptor. For example, the descriptor may identify a known entity but the descriptor may be unknown to the alert system, the descriptor may not identify a known entity at all, and/or the descriptor may not be matched to a known entity for other reasons. Regardless of reason, the alert system may be unable to forward the alert message to the recipient entity identified by the descriptor. In some instances, the descriptor may encode data elements having content that may be used to identify the recipient entity. However, because at least portions of the descriptor can be unstructured, the data elements and/or order in which the data elements appear may vary between descriptors. Thus, it may be computationally difficult to decode the descriptors in a meaningful way to identify recipient entities. Furthermore, even if decoding is performed to match a descriptor to a known entity, the match is prone to mismatch errors because of the variability of the descriptors and errors in the descriptors or data records of known entities. These and other issues may exist for identifying entities using unstructured descriptors and routing alert messages between entities in a computer network.

### BRIEF DESCRIPTION OF THE DRAWINGS

Features of the present disclosure may be illustrated by way of example and not limited in the following figure(s), in which like numerals indicate like elements, in which:

FIG. 1 illustrates an example of a computer environment for matching data records and validating matched data records based on a machine learning-based match classifier (ML match classifier);

FIG. 2 illustrates an example of a data flow of the computer system illustrated in FIG. 1;

FIG. 3 illustrates an example of a method of matching unmatched descriptors;

FIG. 4 illustrates an example of a method of validating matches based on the ML match classifier;

FIG. 5 illustrates an example of a method for matching unmatched descriptors and validating the matches based on a ML match classifier; and

FIG. 6 illustrates an example of a computer system that may be implemented by devices illustrated in FIG. 1.

### DETAILED DESCRIPTION

The disclosure relates to methods and systems of generating matches between unmatched descriptors and known entities and/or training and using an ML match classifier to generate match classifications. An unmatched descriptor is a descriptor that has not been matched to a known entity. An alert system may be unable to identify a known entity to which to route an alert message when the alert message includes an unmatched descriptor. To identify an entity identified by an unmatched descriptor, a computer system may include a matching subsystem and a ML match classifier trained to generate match classifications. A known entity is an entity for which data records are accessible to computer system or is otherwise identifiable by the computer system.

The matching subsystem may extract one or more data elements from the unmatched descriptor. A data element is a part of the unmatched descriptor that may be used to identify a known entity. If the unmatched descriptor is a string, a data element may be a substring or portion of the string that includes a data value that may be used to identify a known entity. For example, a data element may be a phone number, a Uniform Resource Locator (URL), and/or other content that may be included in an unmatched descriptor and may be used to identify an entity. In some examples, the data elements may include a sub-field that the matching subsystem may further use to identify an entity. The sub-fields may be matched against a name of a known entity and/or may contain other data about the entity.

The matching subsystem may use one or more extraction rules to extract the data elements. Each extraction rule may include logic such as a regular expression or pattern that is used to extract one or more data elements from the unmatched descriptor. An extraction rule may be added or modified to take into account a wide range of unstructured content that may be included in descriptors. Once data elements have been extracted, the matching subsystem may compare each data element with data records of known entities. For example, the matching subsystem may look up an extracted phone number, a URL, a sub-field, and/or content extracted from the unmatched descriptor and compare each to the data records of known entities. In some examples, the matching subsystem may attempt to match a portion of the unmatched descriptor with a name of a known entity.

The matching subsystem may identify a plurality of matches. Each match represents a data element that has a fuzzy or exact match to a data record of a known entity. In some examples, multiple matches may identify the same known entity (such as when a phone number and URL match occurs). In some examples, multiple matches may identify different known entities such as when an extracted URL matches a URL of one known entity and a part of an extracted name has a fuzzy match with a name of another known entity. Thus, the matching subsystem match an unmatched descriptor with zero, one, or multiple potential known entities to which a given unmatched descriptor.

The matching subsystem may identify one or more candidate matches from among the plurality of matches A candidate match is a match that the matching subsystem deems to be a valid match, indicating that the unmatched descriptor identifies a corresponding known entity. The matching subsystem may identify candidate matches by ranking the plurality of matches and selecting top N matches, where N is an integer. In some instances, the matching subsystem may identify candidate matches based on a type of data element that matched. For example, any phone number match, an exact sub-field match, and/or other types of matches may be deemed to be a candidate match.

Due to unstructured nature of unmatched descriptors, a candidate match may be a false positive match. To reduce false positive matches, the system may train and execute an ML match classifier to validate matches, such as candidate matches, generated by the matching subsystem. The ML match classifier is a machine learning model trained on features derived from similarity metrics between pairs of inputs such as strings that have been labeled as matched or mismatched. For example, the pairs of inputs in the training data may include pairs of entity names that are labeled as matched or mismatched. In this example, a matched label indicates that a pair of entity names (features derived from the pair) identify the same entity, while a mismatched label indicates that the pair of entity names identify different entities.

To validate a match, the system may use a name associated with the unmatched descriptor (such as an entity name of an entity identified by the unmatched descriptor) and a name of the known entity. The system may generate features derived from this pair of names and input the features to the ML match classifier In these examples, the match subsystem may identify matches using extracted data from unmatched descriptors and the ML match classifier may independently validate the identified matches.

The system may generate the features for training and executing the ML match classifier by computing similarity metrics between a pair of inputs, such as pairs of names in the training data for training or the pair of names associated with a candidate match for validating a match. Each similarity metric may measure a level of similarity between the pair of inputs. In particular, the system may generate a feature vector based on the similarity metrics. The feature vector is a numerical representation of the similarity metrics ordered in a way that the ML match classifier can apply consistently during training and execution For example, the feature vector may be an N-dimensional vector (such as an N-dimensional array) of N-values in which N is the number of similarity metrics computed between the pair of input strings.

During training, the pair of inputs may include pairs of training data labeled as a match or mismatch. In this way, the ML match classifier is trained to generate a match classification that indicates whether or not a given pair of inputs match one another. The match classification may include a one-class classification (either match or mismatch) or a binary classification (match or mismatch). In some examples, the match classification may be a regressive classification that indicates a probability of a match and/or mismatch.

If the match classification indicates a match, the candidate match from the matching subsystem is validated. In this example, the computer system may report back to the alert system that the unmatched descriptor has been matched with an entity in the candidate match. The alert system may then transmit an alert message to the entity in the candidate match and/or take other mitigative action.

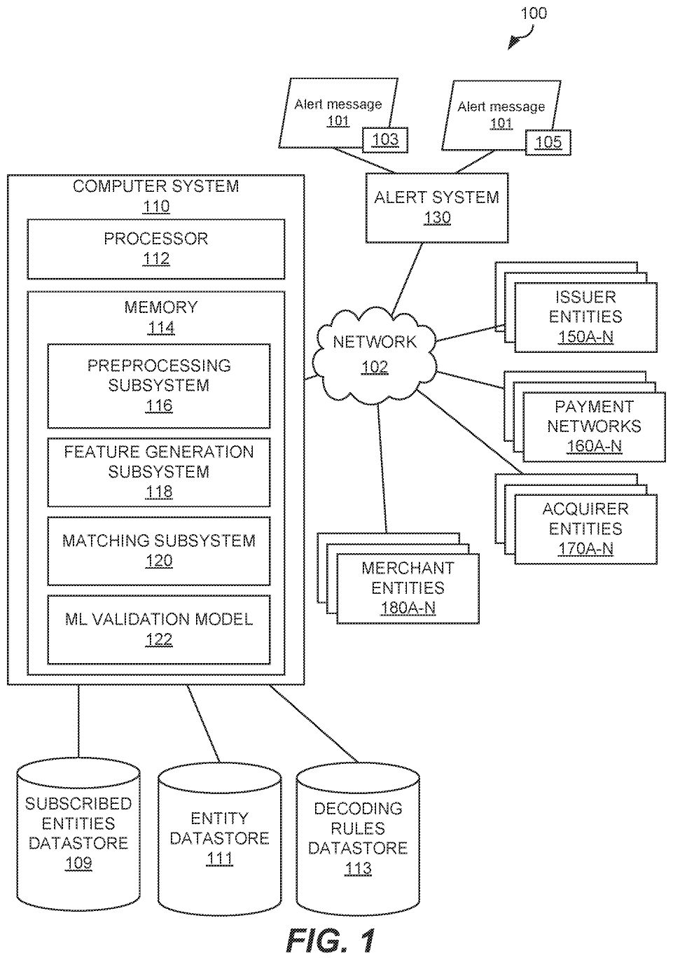

Having described a high-level overview of system operations and example use of the system, attention will now turn to an example of a system environment in which unmatched descriptors are matched to known entities For example, FIG. 1 illustrates an example of a computer environment 100 for matching data records and validating matched data records based on a machine learning-based match classifier (ML match classifier) 122. The system environment 100 may include a computer system 110, an alert system 130, issuer entities 150 (illustrated as issuer entities 150A-N), payment networks 160 (illustrated as payment networks 160A-N), acquirer entities 170 (illustrated as acquirer entities 170A-N), merchant entities 180 (illustrated as merchant entities 180A-N), and/or other features. At least some of the components of the system environment 100 may be connected to one another via a network 102, which may include the Internet, an intranet, a Personal Area Network, a LAN (Local Area Network), a WAN (Wide Area Network), a SAN (Storage Area Network), a MAN (Metropolitan Area Network), a wireless network, a cellular communications network, a Public Switched Telephone Network, and/or other network through which system environment 100 components may communicate.

The alert system 130 may receive and share alert messages 101 among a network of entities. An alert message 101 is electronic data that indicates an anomalous state that should be investigated, mitigated, or otherwise resolved by an entity in the network of entities. To share an alert message 101, the alert system 130 may identify the relevant entity that should act on the anomalous state and transmit an alert message 101 to the identified entity.

For example, in an electronic payment context, the network of entities may include issuer entities 150A-N, acquirer entities 170A-N and merchant entities 180A-N. An alert message 101 may indicate a transaction submitted through a payment network 160 should be rejected, mitigated, and/or investigated by an entity such as a merchant. In this example, an alert message 101 may include a descriptor 103 that identifies a merchant entity 180. In a network security context, an alert message 101 may indicate a potential network intrusion event that should be contained, mitigated, and/or investigated by an entity such as a network administrator. In this example, an alert message 101 may include a descriptor 103 that identifies a particular network administrator or system to alert the administrator of a potential network intrusion event. The alert system 130 may implement other types of alert contexts.

In some instances, the alert system 130 may be unable to identify the relevant entity based on a descriptor 103 encoded by an alert message 101. To illustrate, an example in the electronic payment context will be elaborated. When an issuer entity 150 detects suspicious activity such as fraud relating to a transaction at a merchant entity 180 using one of its issued accounts (such as when a credit card or other payment method linked to an issued account is used at the merchant entity 180), the issuer entity 150 may transmit an alert message 101 to the alert system 130. The alert message 101 may include a descriptor 103, a card acceptor name, and/or other information relating to the transaction. The descriptor 103 may describe a party requesting payment and may include a string that is presented on an account statement provided to the account holder. The descriptor 103 is intended to provide information about the party requesting payment so that the account holder can recognize the transaction. The card acceptor name may include a name of the merchant entity 180 that requested payment from the issuer entity 150.

Responsive to the alert message 101, the alert system 130 may identify the merchant entity 180 by looking up the descriptor 103 and/or the card acceptor name in an internal subscribed entities datastore 109 that stores identities of entities that have subscribed to receive and/or share alert messages 101. The alert system 130 may transmit an alert to the identified merchant entity 180 indicating the suspicious activity. In response, the merchant entity 180 may intervene by cancelling the transaction or refunding an amount of the transaction to avoid chargeback processing from the account holder.

The merchant entity 180 may report the interventive action or other information to the alert system 130. The refund may be initiated by the merchant entity 180 through its acquirer entity 170, which may submit a refund transaction to the appropriate payment network 160. Because such refunds generally occur within a specified time after the transaction (and alert from the issuer entity 150 was transmitted), refunds occurring within a threshold time period may be deemed to be related to the original alert. The threshold time period may be set to the length of time it usually takes for a payment transaction to reach settlement, typically 24 to 48 hours, although other threshold time periods may be used.

In some instances, the alert system 130 may not recognize the descriptor 103 and/or the card acceptor name. This may be because the merchant entity 180 is unknown to the alert system 130 such as when the merchant entity 180 has not subscribed to receive alert messages 101, the descriptor 103 and/or the card acceptor name have changed, the merchant entity 180 is using a new descriptor 103, and/or other reasons. In many of these examples, the descriptor 103 contains information that may be used to identify the merchant entity 180. However, the descriptor 103 may be unstructured and therefore difficult to match with previously stored information of known entities such as known merchant entities 180.

Table 1 illustrates the unstructured nature of data elements in a descriptor 103. The data elements 1-3 are shown for illustrative purposes. Other numbers and combinations of data elements may be used. In the examples of Table 1, the content and/or order in which the content is encoded in one descriptor 103 may be different than the content and/or order in which the content is encoded in another descriptor 103.

| | | Data element | | Data element 3: |
|---|---|---|---|---|
| | | 1: Entity | Data element | One or more |
| Entry | Descriptor | Phone number | 2: URL | Sub-fields |
| 103A | abcmerchant.com*12345678 | None | abcmerchant.com | Prefix, Suffix, |
| | | | | other portions |
| 103B | abcmerchant.com*11223344 | None | abcmerchant.com | Prefix, Suffix, |
| | | | | other portions |
| 103C | abcmerchant.com*11223344 | None | abcmerchant.com | Prefix, Suffix, |
| | | | | other portions |
| 103D | MY*MART 1-800-555-1234 | 18005551234 | None | Prefix, Suffix, |
| | | | | other portions |
| 103E | Fitness-Gym 18005554321 | 18005554321 | None | Prefix, Suffix, |
| | CT US | | | other portions |
| 103F | 8005551144OnlineRetailer | 8005551144 | None | Prefix, Suffix, |
| | | | | other portions |
| 103G | 22313 MyLocalRetailer | None | None | Prefix, Suffix, |
| | | | | other portions |
| 103H | Grand9 Motels * 8885551212 | 8885551212 | None | Prefix, Suffix, |
| | | | | other portions |

The unstructured format of descriptors 103 may make it difficult for a computer system to decode descriptors 103 in a consistent manner. Furthermore, a given descriptor 103 may be unrecognized because it is new, has not otherwise been used before, has errors, and/or other issues. As a result, it may be difficult to computationally match a particular descriptor 103 to descriptors of known entities. A descriptor that is not recognized as identifying a known entity, such as a known merchant entity 180, will be referred to as an “unmatched descriptor” 105. The alert system 130 may be unable to transmit an alert message 101 having an unmatched descriptor 105 to the relevant entity because the relevant entity is not identifiable based on the unmatched descriptor 105. On the other hand, an alert message 101 having a descriptor 103 will be transmitted to a merchant entity 180 that is identified by the descriptor 103.

To mitigate against these and other issues, the computer system 110 may include one or more computing devices that decode one or more data elements from unmatched descriptors 105 and match the data elements to data of known entities such as merchant entities 180 stored in the entity datastore 111. Because of the probabilistic nature of the matches, the computer system 110 may further validate the one or more matches by training and using machine learning models to generate a match classification. The match classification may be used by alone and/or to validate matches that were generated based on the unmatched descriptors.

In particular, the one or more computing devices of the computer system 110 may each include a processor 112, a memory 114, and/or other components. The processor 112 may be a semiconductor-based microprocessor, a central processing unit (CPU), an application specific integrated circuit (ASIC), a field-programmable gate array (FPGA), and/or other suitable hardware device. Although the computer system 110 has been depicted as including a single processor 112, it should be understood that the computer system 110 may include multiple processors, multiple cores, or the like. The memory 114 may be an electronic, magnetic, optical, or other physical storage device that includes or stores executable instructions. The memory 114 may be, for example, Random Access memory (RAM), an Electrically Erasable Programmable Read-Only Memory (EEPROM), a storage device, an optical disc, and the like. The memory 114 may be a non-transitory machine-readable storage medium, where the term “non-transitory” does not encompass transitory propagating signals. The memory 114 may store a matching subsystem 120, a pre-processing subsystem 116, a feature generation subsystem 118, and an ML match classifier 122 that may each be executed by the processor 112.

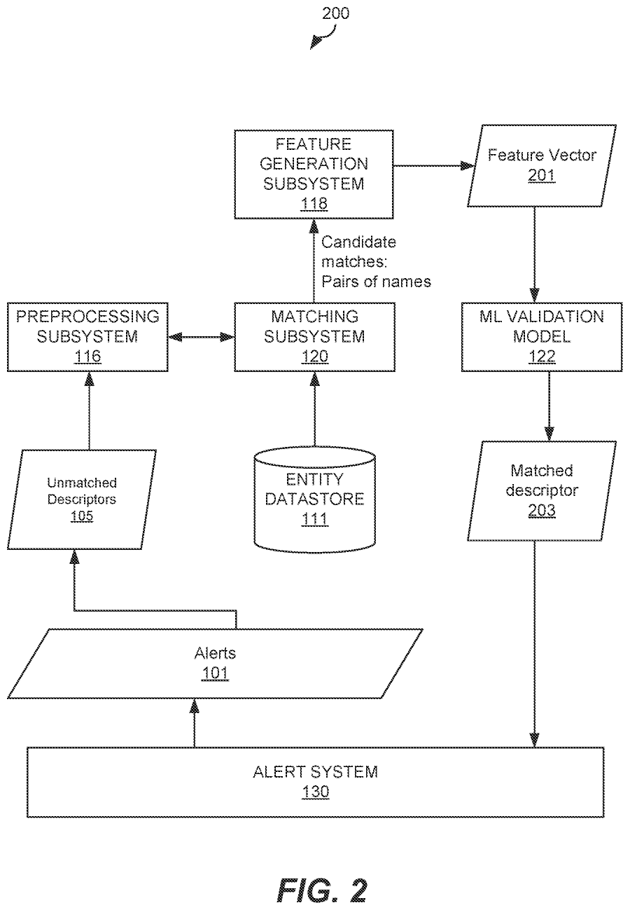

FIG. 2 illustrates an example of a data flow 200 of the computer system 110 illustrated in FIG. 1. The alert system 130 may generate alert messages 101. Some alert messages 101 may include unmatched descriptors 105. The pre-processing subsystem 116 may pre-process the unmatched descriptors 105, entity name such as a card acceptor name, descriptors or names of known entities from the entity datastore 111, and/or other data that will be matched by the matching subsystem 120 or used for the ML match classifier 122. The matching subsystem 120 may identify a known entity to which a given unmatched descriptor 105 relates. In some examples, there may be multiple candidate matches, in which case the matching subsystem 120 may identify the candidate matches. Each candidate match is associated with a pair of names: a name associated with an unmatched descriptor 105 (such as a card acceptor name) and a name of a matching entity (such as a merchant name of a merchant entity 180). The feature generation subsystem 118 may take a pair of names as input and generate a feature vector 201 for input to the ML match classifier 122. The ML match classifier 122 may, for each feature vector 201, generate a match classification that indicates whether the candidate match is a match or mismatch. A candidate match classified as a match by the ML match classifier 122 is considered validated. The corresponding unmatched descriptor 105 will be considered a matched descriptor 203, which is provided back to the alert system 130 with the identity of the known entity in the validated match. Further examples and details of matching and validation will now be described with reference to FIGS. 1 and 3-5.

### Decoding Descriptors to Extract Data Elements

The matching subsystem 120 may extract one or more data elements from unmatched descriptors 105 and compare the extracted data elements to data records in the entity datastore 111 corresponding to known entities, such as merchant entities 180. For example, the matching subsystem 120 may retrieve unmatched descriptors 105 from the alert system 130. The matching subsystem 120 may extract data elements, such as phone numbers, URLs, and subfields from the unmatched descriptors 105. A sub-field may refer to a portion, such as beginning, middle, or ending substring of an unmatched descriptor 105. The matching subsystem 120 may further extract information from sub-fields based on regular expressions or other patterns. For example, certain sub-fields may contain information such as location (city, state, zip code, and the like) or other information that may be decoded from strings using regular expressions or patterns.

The matching subsystem 120 may apply one or more decoding rules stored in the decoding rules datastore 113. Each decoding rule may encode computer-executable logic such as program code to extract a corresponding data element. In a particular example, a decoding rule may include a regular expression, a pattern, and/or other logic that programs a computer to extract specific one or more data elements of interest.

In one example, a decoding rule may encode logic for parsing a phone number from an unmatched descriptor 105. This decoding rule may include a regular expression that parses a number of integers corresponding to phone numbers. In some instances, the regular expression may look for a number of integers that are commonly used in various locales. Thus, the regular expression to parse phone numbers may be locale-specific.

In another example, a decoding rule may encode logic for parsing a URL from an unmatched descriptor 105. In this example, the decoding rule may include a regular expression that parses some or all of the structure of URLs, such as a URL encoding scheme, a subdomain, a second-level domain, a top-level domain, a directory, and/or other parts of a URL.

In another example, a decoding rule may encode logic for parsing a location from an unmatched descriptor 105. In this example, the decoding rule may include a regular expression or pattern that is used to parse zip codes (five or other locale-specific number of integers), abbreviated city, country or other location designations, and/or other location-defining characters in an unmatched descriptor 105.

In yet another example, decoding rule may encode logic for breaking up an unmatched descriptor 105 into further sub-fields. For example, the decoding rule may include a computational split operation that splits a portion or all of a string of the unmatched descriptor 105 into an array of data sub-fields that are separated by a delimiter, such as a regular expression and/or characters such as whitespace.

Other decoding rules may be used to split an unmatched descriptor 105 according to particular contexts in which the system is implemented. It should be noted that some or all of the foregoing examples of decoding rules may be combined together or executed individually.

### Matching Based on Extracted Data Elements

Once the data elements (including sub-fields) are extracted, the matching subsystem 120 may attempt to match the data elements to data of in the entity datastore 111. For example, the matching subsystem 120 may attempt to match phone numbers, URLs, descriptor sub-fields, and/or other information extracted from the unmatched descriptor 105. In some examples, the matching subsystem 120 may perform a prefix match by attempting to match a prefix or other portion of the unmatched descriptor 105 to any portion of data known about an entity stored in the entity datastore 111.

In some examples, matching based on data elements such as phone numbers and URLs may be binary such that either a match is made or it is not. For example, all integers in a phone number extracted from the unmatched descriptor 105 will need to match all integers of a phone number of a known entity to be matched. For URLs, an identifying portion such as a second-level domain of a URL extracted from the unmatched descriptor 105 will need to match a second-level domain of a URL of a known entity to be matched.

In some examples, matching based on strings (such as subfield matches or prefix matches) may be exact or fuzzy. Exact matches are those in which one string completely matches with another string. Thus, an exact match in this context means that a subfield or prefix exactly matches data known about an entity stored in the entity datastore 111, suggesting that the unmatched descriptor 105 matches with that entity. A fuzzy match in this context means that a subfield or prefix does not exactly match data known about an entity stored in the entity datastore 111, but is similar enough beyond a threshold match value. This threshold match value may be predefined based on the length of the unmatched descriptor 105. For example, longer lengths of strings being compared may have larger threshold match values compared to smaller lengths of strings being compared.

In some examples, matching subsystem 120 may apply term frequency-inverse document frequency (TF-IDF) in matching. For example, all or portions of a data element, including any sub-fields, may be searched against data records in the entity datastore 111. The relevance—and therefore potential match—of a given data record to an unmatched descriptor 105 may be based on a term frequency, which is a measure of a number of times in which the data element appears in the data record and an inverse document frequency, which is based on a number of data records that include the data element. Thus, a term from the unmatched descriptor 105 that appears in a data record known about an entity stored in the entity datastore 111 may indicate that the data record is relevant to the unmatched descriptor 105.

On the other hand, if the term appears across multiple data records, this suggests that the term is common in the data records and therefore is not a reliable indicator. This term may not be useful for identifying relevant data records. For example, the matching subsystem 120 may extract a sub-field data element “Grand 9 Motels” from the descriptor “Grand9 Motels*8885551212” using a regular expression or pattern. If different portions of “Grand9 Motels” such as “Grand9” and “Motels” are used as terms to identify potential matches to known entities, then “Motels” may be identified as an unsuitable term to use based on the prevalence of the word “Motels” in different data records of known entities. On the other hand, “Grand9” may not be as common among different data records of known entities and therefore matching this term to a data record may suggest that the data record is relevant to the unmatched descriptor 105.

The matching subsystem 120 may identify one or more candidate matches from among the plurality of matches. A candidate match is a match that the matching subsystem deems to be a valid match, indicating that the unmatched descriptor identifies a corresponding known entity. The matching subsystem 120 may identify candidate matches by ranking the plurality of matches and selecting top N matches, where N is an integer. In some instances, the matching subsystem 120 may identify candidate matches based on a type of data element that matched. For example, any phone number match, an exact sub-field match, and/or other types of matches may be deemed to be a candidate match. Due to unstructured nature of unmatched descriptors, a candidate match may be a false positive match. To mitigate against such false positive matches, the system may train and execute the ML match classifier 122 to validate matches, such as candidate matches, from the matching subsystem.

In some examples, the matching subsystem 120 may identify candidate matches from among the data elements that were extracted and matched to data records of known entities. To identify candidate matches, the matching subsystem 120 may rank each of the matches and select the top N matches, where N is an integer. evaluate the type of data element that was matched, whether there was an exact or fuzzy match, whether all or a portion of a data element matched, and/or other match criteria. For string-based matches, the evaluation may include some or all of the similarity metrics illustrated in Table 2, in which a higher similarity score based on the similarity metrics are ranked higher than a lower similarity score.

Candidate matches may be identified within each type of data element and/or across all types of data elements. For example, identifying candidate matches within each type of data element may include identifying best URL matches from among the URL matches, best phone number matches from among the phone number matches, best location matches from among the location matches, and best sub-field matches from among the sub-field matches. The term “best” means the top-scoring or highest likelihood match output based on a given data element comparison. For example, second URL sub-match may be determined to be the candidate matching URL. As such, the second entity may be determined to be a candidate match for the URL data element. Likewise, the exact prefix match for the third entity may be determined to be the candidate matching entity name match. As such, the third entity may be determined to be a candidate match for the entity name data element.

Identifying candidate matches across all types of data elements may include identifying candidate matches irrespective of the type of data element that was compared. For example, identifying candidate matches across all types of data elements may include determining whether a phone number match is better than a location match.

### Pre-Processing

The pre-processing subsystem 116 may pre-process descriptors such as unmatched descriptors 105. To address the variability of unmatched descriptors 105, the computer system 110 may perform transformations on each unmatched descriptor 105. For example, each unmatched descriptor 105 may be transformed prior to matching by the matching subsystem 120 and/or prior to validation by the ML match classifier 122. The transformations may include one or more of the following, in combination or individually: characters are converted to a common case (such as all upper case or all lower case); some or all special characters are replaced by whitespaces (in some examples “dash” characters are retained); trailing and/or leading white spaces are removed; inner sequences of whitespaces are collapsed into a single whitespace; non-English characters are replaced by their English equivalent when applicable (for example: the word “Marché” becomes “Marche”). Other transformations may be performed during pre-processing. Descriptors in the entity datastore 111 may be similarly transformed for matching by the matching subsystem 120 and/or the ML match classifier 122.

### Feature Generation

The feature generation subsystem 118 may generate features for training and executing the ML match classifier 122. The feature generation subsystem 118 may generate the features by computing similarity metrics between a pair of input strings The feature generation subsystem 118 may generate a feature vector based on the similarity metrics. A feature vector is a numerical representation of the similarity metrics ordered in a way that the ML match classifier 122 can apply consistently during training and execution. For example, the feature vector may be an N-dimensional vector (such as an N-dimensional array) of N-values in which N is the number of similarity metrics computed between the pair of input strings.

During training, the pair of input strings may include pairs of training data labeled as a match or mismatch. In this way, the ML match classifier 122 may be trained to generate a match classification that indicates whether or not a given pair of input strings match one another. The match classification may include a one-class classification (either match or mismatch) or a binary classification (match or mismatch). In some examples, the match classification may be a regressive classification that indicates a probability of a match and/or mismatch.

Table 2 illustrates examples of similarity metrics used to generate input features. It should be noted that one or more of the similarity metrics may be used for matching by the matching subsystem 120 as well.

| Feature name | Type | Description |
|---|---|---|
| edit_distance | Number | The edit distance between an input pair. A |
| | | smaller value (i.e. close to 0) indicate that |
| | | the members in the input pair are closer to |
| | | each other. |
| Jaccard_distance | Number | The jaccard distance between an input |
| | | pair. A smaller value (i.e. close to 0) |
| | | indicate that members in the input pair |
| | | are closer to each other. |
| Jarro_distance | Number | The jarro distance between the two names. |
| | | A value close to 1 indicate that the members |
| | | in the input pair are closer to each other. |
| Jarro_winkler_distance | Number | The jarro-winkler distance between the two |
| | | names. A value close to 1 indicate that the |
| | | members in the input pair are closer to |
| | | each other. |
| Cosine_distance | Number | The cosine distance between the two |
| | | names. A smaller value (i.e. close to 0) |
| | | indicates that the members in the input pair |
| | | are closer to each other. Each member in |
| | | the input pair may first be converted to a |
| | | vector. Each index of the vector corresponds |
| | | to an ASCII character and the number at |
| | | that index correspond to the number of |
| | | occurrences of that character in the name. |
| match_directly | Boolean | 1 if the members in the input pair are equal, |
| | | 0 otherwise. |
| common_special_chars_count | Number | The number of common special characters |
| | | in the members in the input pair are. |
| longest_subseq | Number | The length of the longest common subsequence |
| | | shared in the members in the input pair. |
| common_bigrams_count | Number | The number of common bigrams in the |
| | | members in the input pair. |
| common_trigrams_count | Number | The number of common trigrams in the |
| | | members in the input pair. |
| diff_length | Number | The difference of the lengths of the |
| | | members in the input pair. |
| acronym_match | Boolean | 1 if the acronym generated from the |
| | | members in the input pair match, 0 |
| | | otherwise. The acronym is generated by |
| | | concatenating the first letters of |
| | | each word in the members in the input pair. |

### Match Classification, Including Match Validation Based on Names

The ML match classifier 122 is a model that is trained to generate a match classification, which indicates whether a pair of inputs are matched. A pair of inputs such as two strings are deemed to be matched when they are determined to identify the same entity. The pair of inputs may be strings such as a card acceptor name associated with an alert message 101 and a merchant name associated with a known merchant in the entity datastore 111. In these examples, the ML match classifier 122 may determine whether a card acceptor name associated with an unmatched descriptor 105 is matched to a merchant name associated with a known merchant in the entity datastore 111.

In some examples, the ML match classifier 122 is an ensemble model such as a random forest model. A random forest model is a meta estimator that fits a number of decision tree classifiers on various sub-samples of the dataset and uses averaging to improve predictive accuracy and control over-fitting. The dataset may include input feature vectors generated by the feature generation subsystem 118. A decision tree includes a plurality of nodes. Each node may be split into two or more branches that represent a decision based on an input value from the input vector that is applied by that node. A matched pair may be evaluated by each decision tree in the random forest. In some examples, each decision tree may output a probability that the input pair matches one another and/or a probability that the input pair is mismatched. In some examples, each decision tree may output a vote, such as a binary yes/no decision, on whether the input pair matches one another.

Each decision tree in the ensemble is built from a sample drawn with replacement from the training set, which may include labeled pairs of matches and/or mismatches. In some examples, the match classification generated by the ML match classifier 122 is based on an average of the probabilistic outputs of each decision tree. In other examples, the match classification is based on a voting count of each decision tree in which the classification is based on a total number of votes for a match and a total number of votes for a mismatch. When splitting each node during the construction of a decision tree, the best split is found either from all input features or a random subset of input features, which may be parameterized as a maximum number of features parameter. The random subsets may decrease the variance of the forest estimator. Individual decision trees may exhibit high variance and tend to overfit. The introduced randomness may mitigate against these and other prediction errors. For example, by taking an average of those predictions, some errors may cancel out. Random forests achieve a reduced variance by combining diverse trees, sometimes at the cost of a slight increase in bias.

### Data Labeling

In some examples, the ML match classifier 122 is a supervised model. In these examples, labelled data may be used train the model. To obtain labelled data, a manual labelling process is used in which a user assigns a label (Match or Mismatch) to a pair of names The user may assign the labels based on the similarity of the pair of names to one another and/or other data elements that are associated with the pair of names The other data elements may include location such as city, locality, and country associated with the entities identified by the names and/or other data that may indicate whether the pair of names are matched are mismatched. Labeling may also include use of third party services such as online web search engines to verify matches or mismatches. For example, if the names in a pair are the same but their associated locations are different, a web search engine may be consulted to help disambiguate whether the names relate to the same entity and, if so, a match label may be assigned. In another example, if the names in a pair are different but their associated locations match, a web search engine may be consulted to help disambiguate whether the names relate to the same entity and, if so, a match label may be assigned.

Through this process, a total of ˜49K of records were labelled over ˜395K records available. The labelled data did not include records where the merchant names was MERCHANT_NOT_FOUND, UNKNOWN, UNKNOWN_MERCHANT, UNKNOWN_SQUARE_MERCHANT because in such case there is no way to know the exact name of the merchant, hence, to compare it correctly to the input card acceptor name.

### Model Training

The ML match classifier 122 may be trained over multiple experiments. In some examples, 70% of the labelled data is used for training and 30% of the labelled data is used for model evaluation. Other proportions such as an 80:20 training: evaluation proportion may be used instead. Model parameters may be optimized based on the experiments using a grid search for determining the optimal values for the following model parameters. Model parameters may include, for example, a number of decision trees in the forest, criteria to evaluate a split, and maximum number of features to consider when looking for the best split.

Table 3 illustrates example values for model parameters that were optimized specifically for the ML match classifier 122.

| Parameter | Value | Description |
|---|---|---|
| n_estimators | 500 | The number of trees in the forest. |
| criterion | entropy | The measure used to evaluate the |
| | | quality of a split. |
| max_features | auto | The number of features to consider |
| | | when looking for the best split. |

To evaluate the model, the following metrics were used, the accuracy, the ROC Curve, the Matthew Correlation Coefficient, the Match recall, and the Mismatch recall. Other evaluation metrics may be used as well or instead of any of the foregoing examples.

### Model Execution

The ML match classifier 122 may take as input a feature vector. The feature vector may be generated by the feature generation subsystem 118. For instance, to validate a match of a pair of descriptors outputted by the matching subsystem 120, the computer system 110 may identify a first name associated with an unmatched descriptor 105 and a second name associated with a descriptor of the known entity. In the payment context, the first name may be the card acceptor name of a merchant entity that is being matched and the second name may be a merchant name of a known merchant entity. The feature generation subsystem 118 may compute one or more of the similarity metrics illustrated in Table 2 and generate a feature vector for the card acceptor name and merchant name pair based on the computed similarity metrics. Because the ML match classifier 122 is specifically trained on labelled training data with features based on the similarity metrics, the ML match classifier 122 generate a match classification based on the input feature vector. The match classification may indicate whether there is a match or mismatch between the first name (such as the card acceptor name) and the second name (such as the merchant name). In some examples, the match classification may include a probability that of a match (or mismatch). In some examples, the match classification may include a binary indication of a match (or mismatch).

If the match classification indicates a match, the output of the matching subsystem 120 is validated, which indicates that the card acceptor name identifies the same merchant entity as the merchant name. In this example, the computer system 110 may report back to the alert system 130 that the unmatched descriptor 105 matches with the merchant entity. The alert system 130 may then transmit an alert message to the merchant entity or take other mitigative action.

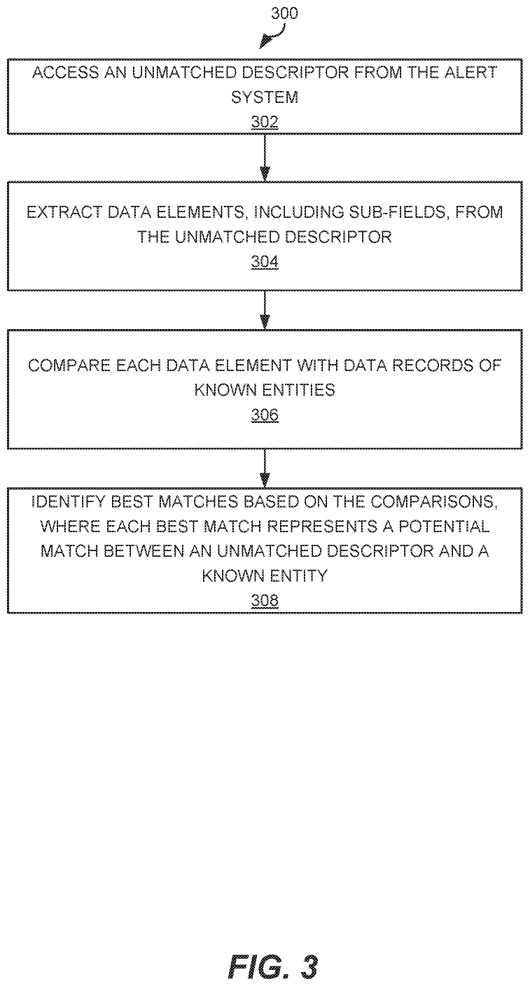

FIG. 3 illustrates an example of a method 300 of matching unmatched descriptors 105. The matching subsystem 120 may execute the method 300 for matching.

At 302, the method 300 may include accessing an unmatched descriptor 105.

At 304, the method 300 may include extracting one or more data elements from the unmatched descriptor 105. Each data element (such as data elements 1-3 illustrated in Table 1) may include data that may be used to match the unmatched descriptor 105 with a known entity from the entity datastore 111. For example, a phone number, if encoded in and extracted from the unmatched descriptor 105 may be matched against the phone numbers of known entities. In another example, a URL, if encoded in and extracted from the unmatched descriptor 105 may be matched against the URLs of known entities. In another example, an entity location, if encoded in and extracted from the unmatched descriptor 105 may be matched against the locations of known entities. Other data elements may be extracted as well, such as portions of the unmatched descriptor 105 that may match to entity names.

At 306, the method 300 may include comparing each extracted data element with a data record of a known entity from the entity datastore 111. For example, if a phone number, URL, location and/or other data element is extracted, the extracted phone number, URL, location, and/or other data element may be compared against any known phone numbers, URLs, locations, and/or other data elements of known entities to produce a match sub-score for each compared data element. Likewise, sub-fields such as portions of a string of the unmatched descriptor 105 may be compared with the name or other data record of a known entity to generate a match sub-score for each sub-field. In some examples, the highest sub-score will be selected for a given unmatched descriptor 105 and entity pair. To illustrate, the URL of an unmatched descriptor 105 may at least partially match a first URL (“amerchants(.)com”) of a first known entity, resulting in a first URL match sub-score. The URL may also at least partially match a second URL (“abmerchant(.)com”) of a second known entity, resulting in a second URL match sub-score.

The comparisons may continue for other extracted data elements. For example, a prefix (which is an example of a sub-field) of the unmatched descriptor 105 may have an exact prefix match to a third known entity named “abcmerchant.com” because the prefix of exactly matches the name of the third known entity, resulting in a first subfield match sub-score for the exact prefix match. The prefix of the unmatched descriptor 105 may also have a fuzzy prefix match to a fourth known entity named “a-to-b-merchant(.)com” because the prefix of has a fuzzy match to the name of the fourth known entity, resulting in a second subfield match sub-score for the fuzzy prefix match. In the foregoing examples, based on the data element comparisons made at 306, there are four known entities that are potential matches to the unmatched descriptor 105.

At 308, the method 300 may include identifying candidate matches based on the comparisons. Each of the candidate matches represent a predicted match between an unmatched descriptor 105 and corresponding known entity In other words, each candidate match represents a determination that the unmatched descriptor pertains to the known entity.

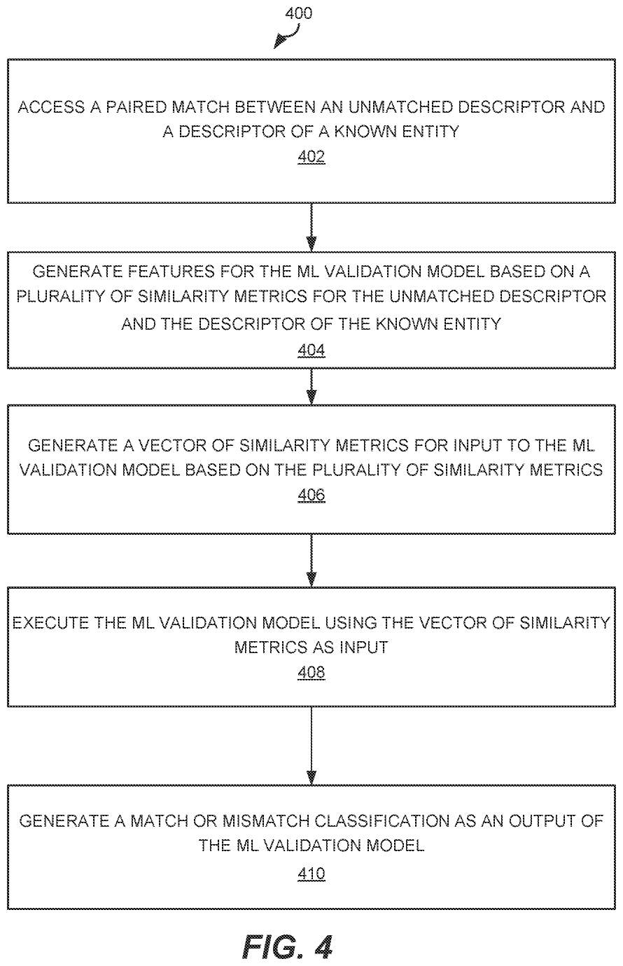

In some examples, the candidate matches may be transmitted back to the alert system 130 for further processing. For example, the alert system 130 may transmit an alert message to one or more of the entities that were candidate matches. In other examples, the candidate matches may be validated by the ML match classifier 122, which may classify each of the candidate matches as a valid match or invalid match. For example, FIG. 4 illustrates an example of a method 400 of validating matches based on the ML match classifier 122

At 402, the method 400 may include accessing an unmatched descriptor 105 and a descriptor of a known entity. In some examples, the unmatched descriptor 105 may have been matched with the descriptor of the known entity by the matching subsystem 120 and the method 400 may include validating the match based on the ML match classifier 122. In other examples, ML match classifier 122 may be used to match the unmatched descriptor 105 and a descriptor of a known entity to determine whether they match without an initial match by the matching subsystem 120.

At 404, the method 400 may include generating features based on a plurality of similarity metrics for the unmatched descriptor and the descriptor of the known entity. The features may be generated as described in FIG. 1 with respect to the feature generation subsystem 118.

At 406, the method 400 may include generating a feature vector for input to the ML match classifier 122 based on the plurality of similarity metrics.

At 408, the method 400 may include executing the ML match classifier 122 using the feature vector as input.

At 410, the method 400 may include generating a match or mismatch classification as an output of the ML match classifier 122. A match classification indicates that the unmatched descriptor 105 and the descriptor of the known entity are predicted by the ML match classifier 122 to match. In some examples, this indicates that a match between the unmatched descriptor 105 and the descriptor of the known entity identified by the matching subsystem 120 is valid. A mismatch classification indicates that the unmatched descriptor 105 and the descriptor of the known entity are predicted by the ML match classifier 122 not to match. In some examples, this indicates that a match between the unmatched descriptor 105 and the descriptor of the known entity identified by the matching subsystem 120 is invalid. Based on the tag provided from the ML validation model, only the ‘Match’ tags will be forwarded to the alert system 130 for further use.

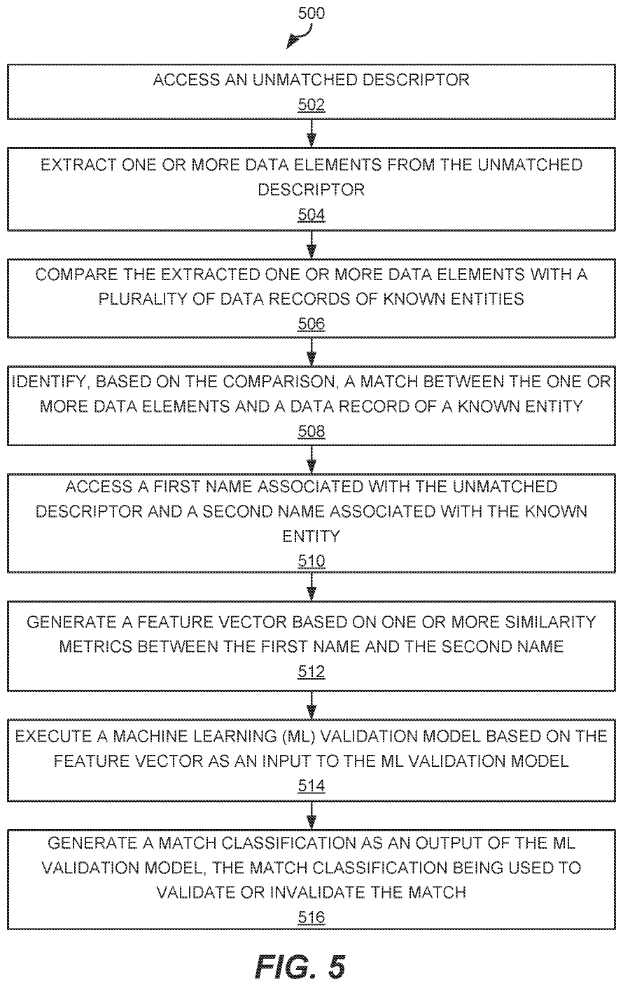

FIG. 5 illustrates an example of a method 500 for matching unmatched descriptors and validating the matches based on a ML match classifier.

At 502, the method 500 may include accessing an unmatched descriptor.

At 504, the method 500 may include extracting one or more data elements from the unmatched descriptor.

At 506, the method 500 may include comparing the extracted one or more data elements with a plurality of data records of known entities.

At 508, the method 500 may include identifying based on the comparison, a match between the one or more data elements and a data record of a known entity.

At 510, the method 500 may include accessing a first name associated with the unmatched descriptor and a second name associated with the known entity.

At 512, the method 500 may include generating a feature vector based on one or more similarity metrics between the first name and the second name.

At 514, the method 500 may include executing a machine learning (ML) validation model based on the feature vector as an input to the ML validation model, the ML validation model being trained based on training data comprising a plurality of features derived from the one or more similarity metrics between paired records, the training data being labeled to indicate whether a paired record is known to be matched.

At 516, the method 500 may include generating a match classification as an output of the ML validation model, the match classification being used to validate or invalidate the match.

At least some of the components of the system environment 100 may be remote from one another. In these examples, the components may communicate via a network, which may include the Internet, an intranet, a Personal Area Network, a LAN (Local Area Network), a WAN (Wide Area Network), a SAN (Storage Area Network), a MAN (Metropolitan Area Network), a wireless network, a cellular communications network, a Public Switched Telephone Network, and/or other network through which the components of the system environment 100 may communicate.

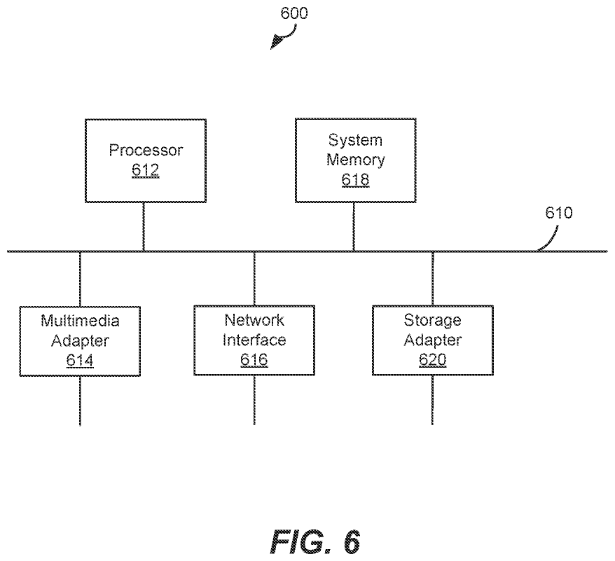

FIG. 6 illustrates an example of a computer system 600 that may be implemented by the computer system 110 illustrated in FIG. 1. For example, the computer system 110 may be implemented based on some or all of the computer system 600. The computer system 600 may include, among other things, an interconnect 610, a processor 612, a multimedia adapter 614, a network interface 616, a system memory 618, and a storage adapter 620.

The interconnect 610 may interconnect various subsystems, elements, and/or components of the computer system 600. As shown, the interconnect 610 may be an abstraction that may represent any one or more separate physical buses, point-to-point connections, or both, connected by appropriate bridges, adapters, or controllers. In some examples, the interconnect 610 may include a system bus, a peripheral component interconnect (PCI) bus or PCI-Express bus, a HyperTransport or industry standard architecture (ISA)) bus, a small computer system interface (SCPI) bus, a universal serial bus (USB), IIC (I2C) bus, or an Institute of Electrical and Electronics Engineers (IEEE) standard 1384 bus, or “firewire,” or other similar interconnection element.

In some examples, the interconnect 610 may allow data communication between the processor 612 and system memory 618, which may include read-only memory (ROM) or flash memory (neither shown), and random-access memory (RAM) (not shown). It should be appreciated that the RAM may be the main memory into which an operating system and various application programs may be loaded. The ROM or flash memory may contain, among other code, the Basic Input-Output system (BIOS) which controls basic hardware operation such as the interaction with one or more peripheral components.

The processor 612 may control operations of the computer system 600. In some examples, the processor 612 may do so by executing instructions such as software or firmware stored in system memory 618 or other data via the storage adapter 620. In some examples, the processor 612 may be, or may include, one or more programmable general-purpose or special-purpose microprocessors, digital signal processors (DSPs), programmable controllers, application specific integrated circuits (ASICs), programmable logic device (PLDs), trust platform modules (TPMs), field-programmable gate arrays (FPGAs), other processing circuits, or a combination of these and other devices.

The multimedia adapter 614 may connect to various multimedia elements or peripherals. These may include devices associated with visual (e.g., video card or display), audio (e.g., sound card or speakers), and/or various input/output interfaces (e.g., mouse, keyboard, touchscreen).

The network interface 616 may provide the computer system 600 with an ability to communicate with a variety of remote devices over a network. The network interface 616 may include, for example, an Ethernet adapter, a Fibre Channel adapter, and/or other wired- or wireless-enabled adapter. The network interface 616 may provide a direct or indirect connection from one network element to another and facilitate communication and between various network elements. The storage adapter 620 may connect to a standard computer readable medium for storage and/or retrieval of information, such as a fixed disk drive (internal or external).

In some examples, the computer system 110 may perform match classification based on output of the matching subsystem 120 alone, output of the ML match classifier 122 alone, or both outputs. When both outputs are used, a match classification outputted by the matching subsystem 120 may be validated by the output of the ML match classifier 122.

Other devices, components, elements, or subsystems (not illustrated) may be connected in a similar manner to the interconnect 610 or via a network. The devices and subsystems can be interconnected in different ways from that shown in FIG. 6. Instructions to implement various examples and implementations described herein may be stored in computer-readable storage media such as one or more of system memory 618 or other storage. Instructions to implement the present disclosure may also be received via one or more interfaces and stored in memory. The operating system provided on computer system 600 may be MS-DOS®, MS-WINDOWS®, OS/2®, OS X®, IOS®, ANDROID®, UNIX®, Linux®, or another operating system.

The term “model” may refer to computer functions that provide functionality described with respect to that model. Such functionality may be “automatic” in that the model may provide such functionality without human intervention. Throughout the disclosure, the terms “a” and “an” may be intended to denote at least one of a particular element. As used herein, the term “includes” means includes but not limited to, the term “including” means including but not limited to. The term “based on” means based at least in part on. In the Figures, the use of the letter “N” to denote plurality in reference symbols is not intended to refer to a particular number. For example, “201A-N” does not refer to a particular number of instances of 201A-N, but rather “two or more.”

The databases (such as the data structures 109, 111, 113) may be, include, or interface to, for example, an Oracle™ relational database sold commercially by Oracle Corporation. Other databases, such as Informix™, DB2 or other data storage, including file-based (such as spreadsheet or extensible markup language documents), or query formats, platforms, or resources such as OLAP (On Line Analytical Processing), SQL (Structured Query Language), a SAN (storage area network), Microsoft Access™ or others may also be used, incorporated, or accessed. The database may comprise one or more such databases that reside in one or more physical devices and in one or more physical locations The database may include cloud-based storage solutions. The database may store a plurality of types of data and/or files and associated data or file descriptions, administrative information, or any other data. The various databases may store predefined and/or customized data described herein.

The systems and processes are not limited to the specific embodiments described herein. In addition, components of each system and each process can be practiced independent and separate from other components and processes described herein. Each component and process also can be used in combination with other assembly packages and processes. The flow charts and descriptions thereof herein should not be understood to prescribe a fixed order of performing the method blocks described therein. Rather the method blocks may be performed in any order that is practicable including simultaneous performance of at least some method blocks. Furthermore, each of the methods may be performed by one or more of the system components illustrated in FIG. 1.

This written description uses examples to disclose the embodiments, including the best mode, and to enable any person skilled in the art to practice the embodiments, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A system of matching data records and validating the matched data records via machine learning models, comprising:
a processor programmed to:
access an unmatched descriptor;
extract one or more data elements from the unmatched descriptor;
compare the extracted one or more data elements with a plurality of data records of known entities;
identify, based on the comparison, a match between the one or more data elements and a data record of a known entity;
access a first name associated with the unmatched descriptor and a second name associated with the known entity;
generate a feature vector based on one or more similarity metrics between the first name and the second name;
execute a machine learning (ML) validation model based on the feature vector as an input to the ML validation model, the ML validation model being trained based on training data comprising a plurality of features derived from the one or more similarity metrics between paired records, the training data being labeled to indicate whether a paired record is known to be matched; and
generate a match classification as an output of the ML validation model, the match classification being used to validate or invalidate the match.

2. The system of claim 1, wherein to extract the one or more data elements, the processor is further programmed to extract a phone number from the unmatched descriptor; and
wherein to compare the extracted one or more data elements with a plurality of data records of known entities, the processor is further programmed to compare the extracted phone number with a phone number of one or more of the known entities.

3. The system of claim 1, wherein to extract the one or more data elements, the processor is further programmed to extract a uniform resource locator (URL) from the unmatched descriptor; and
wherein to compare the extracted one or more data elements with a plurality of data records of known entities, the processor is further programmed to compare the extracted URL with a URL of one or more of the known entities.

4. The system of claim 1, wherein to extract the one or more data elements, the processor is further programmed to obtain a sub-field from the unmatched descriptor; and
wherein to compare the extracted one or more data elements with a plurality of data records of known entities, the processor is further programmed to compare the obtained sub-field with the plurality of data records of the known entities.

5. The system of claim 1, wherein to extract the one or more data elements, the processor is further programmed to:
apply a plurality of extraction rules for extracting the one or more data elements, wherein a first parse rule encodes logic to extract a first field from among the one or more fields and a second parse rule encodes logic to extract a second field from among the one or more fields.

6. The system of claim 1, wherein the unmatched descriptor is unstructured in which content and/or order of content in the unmatched descriptor is different than content and/or order of content in another unmatched descriptor.

7. The system of claim 1, wherein the processor is further programmed to:
identify a plurality of top matches; and
classify each of the top plurality of matches based on execution of the ML validation model.

8. The system of claim 1, wherein the ML validation model comprises an ensemble model based on a plurality of sub-models.

9. The system of claim 8, wherein an output of an ensemble model from among the plurality of ensemble models is averaged with other ones of the plurality of ensemble models to generate the match classification.

10. The system of claim 8, wherein the ensemble model comprises a random forest model based on a plurality of decision trees.

11. A method, comprising:
accessing, by a processor, an unmatched descriptor;
extracting, by the processor, one or more data elements from the unmatched descriptor;
comparing, by the processor, the extracted one or more data elements with a plurality of data records of known entities;
identifying, by the processor, based on the comparison, a match between the one or more data elements and a data record of a known entity;
accessing, by the processor, a first name associated with the unmatched descriptor and a second name associated with the known entity;
generating, by the processor, a feature vector based on one or more similarity metrics between the first name and the second name;
executing, by the processor, a machine learning (ML) validation model based on the feature vector as an input to the ML validation model, the ML validation model being trained based on training data comprising a plurality of features derived from the one or more similarity metrics between paired records, the training data being labeled to indicate whether a paired record is known to be matched; and
generating, by the processor, a match classification as an output of the ML validation model, the match classification being used to validate or invalidate the match.

12. The method of claim 11, wherein to extract the one or more data elements, the processor is further programmed to extract a phone number from the unmatched descriptor; and
wherein to compare the extracted one or more data elements with a plurality of data records of known entities, the processor is further programmed to compare the extracted phone number with a phone number of one or more of the known entities.

13. The method of claim 11, wherein to extract the one or more data elements, the processor is further programmed to extract a uniform resource locator (URL) from the unmatched descriptor; and
wherein to compare the extracted one or more data elements with a plurality of data records of known entities, the processor is further programmed to compare the extracted URL with a URL of one or more of the known entities.

14. The method of claim 11, wherein to extract the one or more data elements, the processor is further programmed to obtain a sub-field from the unmatched descriptor; and
wherein to compare the extracted one or more data elements with a plurality of data records of known entities, the processor is further programmed to compare the obtained sub-field with the plurality of data records of the known entities.

15. The method of claim 11, wherein to extract the one or more data elements, the processor is further programmed to:
apply a plurality of extraction rules for extracting the one or more data elements, wherein a first parse rule encodes logic to extract a first field from among the one or more fields and a second parse rule encodes logic to extract a second field from among the one or more fields.

16. The method of claim 11, wherein the unmatched descriptor is unstructured in which content and/or order of content in the unmatched descriptor is different than content and/or order of content in another unmatched descriptor.

17. The method of claim 11, wherein the processor is further programmed to:
identify a plurality of top matches; and
classify each of the top plurality of matches based on execution of the ML validation model.

18. The method of claim 11, wherein the ML validation model comprises an ensemble model based on a plurality of sub-models.

19. The method of claim 18, wherein an output of an ensemble model from among the plurality of ensemble models is averaged with other ones of the plurality of ensemble models to generate the match classification.

20. A non-transitory computer readable medium storing instructions that, when executed by a processor, programs the processor to:
access an unmatched descriptor;
extract one or more data elements from the unmatched descriptor;
compare the extracted one or more data elements with a plurality of data records of known entities;
identify, based on the comparison, a match between the one or more data elements and a data record of a known entity;
access a first name associated with the unmatched descriptor and a second name associated with the known entity;
generate a feature vector based on one or more similarity metrics between the first name and the second name;
execute a machine learning (ML) validation model based on the feature vector as an input to the ML validation model, the ML validation model being trained based on training data comprising a plurality of features derived from the one or more similarity metrics between paired records, the training data being labeled to indicate whether a paired record is known to be matched; and
generate a match classification as an output of the ML validation model, the match classification being used to validate or invalidate the match.
